(19) United States
(12) Patent Application Publication
(10) Pub. No.: US 2003/0180431 A1
(43) Pub. Date: Sep. 25, 2003

(54) Flavored coffee compositions with stable flavors and method of making

(75) Inventors: Jerry Douglas Young, Cincinnati, OH (US); Douglas Craig Hardesty, Amelia, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter Gamble Co.

(21) Appl. No.: 10/273,219

(22) Filed: Oct. 17, 2002

Related U.S. Application Data
(60) Provisional application No. 60/335,577, filed on Oct. 22, 2001.

(51) Int. Cl. A23F 5/00

(52) U.S. Cl. 426/594

(57) ABSTRACT

The present invention relates to novel coffee compositions with stable flavor characteristics. In particular, the present invention relates to novel processes for preparing stable, flavored coffee compositions and the products comprising them.

### CROSS REFERENCE TO RELATED APPLICATIONS

This application claims priority to U.S. Provisional Application No. 60/335,577, filed Oct. 22, 2001.

### FIELD OF THE INVENTION

The present invention relates to novel coffee compositions with stable flavor characteristics. In particular, the present invention relates to novel processes for preparing stable, flavored coffee beverages and compositions and the products comprising them.

### BACKGROUND OF THE INVENTION

High quality coffee food and beverage products enjoy considerable popularity and make up an increasingly significant proportion of the diets of many people. However, these high quality coffee products are both expensive to purchase and to produce. One such reason is the cost of the raw materials. Due to the nature of coffee production (e.g., growing cycle, season, location, and the like) it is difficult to offset an increased demand for consumer preferred coffees with additional levels of supply. This supply shortage results in higher production costs for high quality coffee food and beverage products that must eventually be borne by the consumer.

One approach to reducing cost has been the use of blends of high cost and low cost coffee varieties. Expensive coffees having consumer preferred taste characteristics are blended with less expensive, less taste preferred coffees varieties. However, this solution is not without shortcomings. Most notably, the inverse relationship that exists between the use of less preferred coffee varieties and the consumer's positive taste perception of the finished coffee product. As the proportion of “cheaper” coffees used increases, the consumer's positive flavor perception of the finished coffee product decreases.

Additionally, coffee products made from blends of high cost and low cost coffees frequently impose additional processing and production complexities, which in turn can also increase production and consumer purchase cost.

Examples of this approaches can be found in European Patent Application No. 0 282 762 to Varsanyl et al.; EP 0 861 596A1 to Bradbury et al.. Additional examples can be found in U.S. Pat. Nos. 5,993,877 to Ohtake et al.; 5,853,787 to Tamer et al.; 5,229,155 to Weisemann et al.; 2,853,387 to Nutting.

Another approach has been to try and maximize the yield obtained from a given supply of high cost coffee by decreasing the frequency with which the high value, high cost coffees is discarded. Typically, this is accomplished by extending the time which a brewed or extracted coffee is held prior to either serving or disposing. However, as coffee hold-time increases a coffee's flavor is marked by a dramatic degradation in quality resulting from aging reactions. The longer the coffee is held, and the higher the temperature, the more pronounced the degradation. The flavor degradation is especially pronounced in liquid coffees such as brews and extracts. It is not uncommon for the flavor of coffee to become unstable (e.g., suffer from aging) prior to the point at which the expense of producing the coffee has been recovered.

Considerable effort, therefore, has been expended in an attempt to address the consumer acceptance limitations of using low cost coffees in the production of high quality coffee products, and the extended use of high quality coffees. There remains a need in the art for compositions and methods for flavoring coffee that ensures consistent, stable, high product quality, that are easily adaptable to a variety of less costly coffee materials, and are economical and easy to use. Accordingly, it is an object of the present invention to provide compositions and methods which address these needs and provide further related advantages.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 Is a representation of the Coffee Source Component Profile of a Coffee Source.

FIG. 2 Is a representation of a Target Coffee Component.

FIG. 3 Is a representation of a Target Coffee Component.

FIG. 4 Is a flow diagram describing the process steps of one embodiment of the present invention.

### DETAILED DESCRIPTION OF THE INVENTION

The present invention relates to novel coffee compositions with stable flavor characteristics. In particular, the present invention relates to novel processes for preparing stable, flavored coffee compositions and the products comprising them.

### A. DEFINITIONS

As used herein, the term “coffee source” is defined as a beverage source derived from a plant of the Family Rubiaceae, Genus Coffea, from a given region of origin. One skilled in the art will appreciate that by region of origin it is meant a coffee growing region wherein the coffee growing process utilizes identical coffee seedlings. Additionally, a region of origin experiences similar soil conditions, fertilization conditions, growing environment (e.g., rainfall amount, temperature, altitude, sunlight), and pre-roasting process, handling, and storage conditions.

There are many coffee species, however, it is generally recognized by those skilled in the art that there are two primary commercial coffee species, Coffea arabica and Coffea canephora var. robusta. Coffees from the Species arabica are frequently described as “Brazils,” which come from Brazil, or “Other Milds” which are grown in other premium coffee producing countries. Premium arabica countries are generally recognized as including Colombia, Guatemala, Sumatra, Indonesia, Costa Rica, Mexico, United States (Hawaii), El Salvador, Peru, Kenya, Ethiopia and Jamaica. Coffees from the Species canephora var. robusta are typically used as a low cost extender for arabica coffees. These robusta coffees are typically grown in the lower regions of West and Central Africa, India, South East Asia, Indonesia, and Brazil.

The coffee source can be in a variety of forms including, but not limited to, cherries, beans, leaves, and bark. Additionally, the coffee source can take the form of soluble coffee, roast and ground, roasted whole bean, green coffee, and dried or liquid extracts of coffee via aqueous, super-critical fluid, and organic solvent extraction processes. The coffee source can also be caffeinated, decaffeinated, or a blend of both.

As used herein, the term “coffee source component” is defined as one of the taste contributing acids contained within the coffee source. One skilled in the art will appreciate that by the term acid it is meant the combination of the acid's associated and dissociated forms. The coffee source component is generated or formed as a result of coffee source growing, harvesting, processing, roasting, fermentation, preparation, handling and/or storage processes.

As used herein, the term “taste contributing” is defined as an acid contained within the coffee source whose concentration is perceptible by taste at a concentration in water that is identical to the concentration of the acid in the target coffee and is correlated to roasting conditions, or whose concentration varies with coffee region of origin, or whose concentration varies with the coffee species. Perceptible by taste is defined as modifying the sensory perception of one or more of the following beverage flavor characteristics: sweet, salty, bitter, winey, acidy, mellow, bland, sharp, harsh, pungent, and the like.

As used herein, the term “coffee source component profile” is defined as the concentration of coffee source components present within the coffee source. The coffee source component profile can be represented by a graph, a table, or some other suitable visual representation showing the existence and concentrations of coffee source components.

As used herein, the term “supplemental coffee source component” is defined as a taste contributing acid. The taste contributing acid of the supplemental coffee source component corresponds to a target coffee component, though it may exist in the same or a different form of the acid. The supplemental coffee source component can exist in one or more forms selected from the following group: acidic form of the taste contributing acid, anionic form of the taste contributing acid, and metallic and ammonium salts of the taste contributing acid.

As used herein, the term “coffee source component modifier” is defined as a compound, or set of compounds, that adjusts the perceptible concentration of one or more coffee source components. Acceptable coffee source component modifiers include one or more of the following: sodium, magnesium, potassium, hydrogen, calcium, and ammonium cations, in combination with hydroxide, carbonate, bicarbonate, gluconate, and sulfates. The addition of a coffee source component modifier will modify the taste perceptible concentration of one or more coffee source components.

As used herein the term “resulting coffee component” is defined as the combination of a coffee source component and a corresponding supplemental coffee source component.

As used herein the term “resulting coffee component profile” is defined as the concentration of one or more resulting coffee components present within a coffee portion. The resulting coffee component profile can be represented by a graph, a table, or some other suitable visual representation showing the existence and concentrations of resulting coffee components.

As used herein, the term “target coffee” is defined as a desired coffee beverage or coffee composition. The target coffee comprises a coffee element that is generally derived from a bean or a blend of beans from a plant of the Family Rubiaceae, Genus Coffea, from a given region of origin. However, the coffee element of the target coffee can also be derived from a variety of coffee materials including, but not limited to, cherries, beans, leaves, and bark. Additionally, the coffee element of the target coffee can take the form of soluble coffee, roast and ground, roasted whole bean, green coffee, and liquid or dried extracts extracts of coffee via aqueous, super-critical fluid, and organic solvent extraction processes. The coffee element can also be caffeinated, decaffeinated, or a blend of both.

As used herein, the term “target coffee component” is defined as one of the taste contributing acids contained within the coffee element of the target coffee. One skilled in the art will appreciate that by the term acid it is meant the combination of an acid's associated and disassociated forms. The target coffee component is generated or formed as a result of target coffee growing, harvesting, processing, roasting, fermentation, preparation, handling and/or storage processes.

As used herein, the term “target coffee component profile” is defined as the concentration of target coffee components present within the coffee element of the target coffee. The target coffee component profile can be represented by a graph, a table, or some other suitable visual representation showing the existence and concentrations of target coffee components.

### B. COFFEE SOURCE

It has been determined according to the present invention that coffee beverages and compositions that exhibit consumer preferred flavor characteristics may be produced from a variety of coffee sources. The preferred coffee source for a particular use may vary according to considerations of availability, expense, and flavor associated with the coffee source. Additionally, the degree and nature of impurities and other components in the coffee source may be considered. A coffee beverage composition may also be produced from a blend of one or more suitable coffee sources.

The coffee beverages and compositions of the present invention comprise a coffee portion, and may optionally contain additional components, such as foaming agents, mouthfeel enhancing agents, flavorants, creamy components, inert fillers and carriers, sweetening agents, and the like. The coffee portion is comprised of a coffee source, and any supplemental coffee source component and/or coffee source component modifier required.

Coffee sources exist in a variety of forms including, but not limited to, cherries, leaves, bark, soluble coffee, instant coffee, roast and ground, roasted whole bean, green coffee beans, extracts including aqueous, super-critical fluid, and organic solvents, and mixtures thereof. Furthermore, the coffee source can be caffeinated, decaffeinated, or a blend of both. It is recognized that coffee sources suitable for use in the present invention may contain various impurities and/or by-products.

Coffee sources of the present invention are defined by coffee variety (i.e., coffee species and region of origin). By region of origin it is meant a coffee growing region wherein the coffee growing process utilizes genetically similar coffee seedlings. Additionally, a region of origin experiences similar soil conditions, fertilization conditions, growing environment (e.g., rainfall amount, temperature, altitude, sunlight), and pre-roasting process, handling, and storage conditions. The species, region of origin, and coffee growing, harvesting, processing, roasting, fermentation, preparation, grafting, genetic engineering, handling and/or storage process conditions determine the presence and concentration of a given acid in a coffee source.

It has been found that the coffee sources of the present invention contain one or more of the following acids: Formic, Acetic, Propanoic, Butanoic, Pentanoic, Hexanoic, Heptanoic, Octanoic, Nonanoic, Decanoic, Palmitic, Crotonic, Isocrotonic, Hydroxyacetic, Isobutyric, Lactic, 3-hydroxypropanoic, Glyceric, 2,3-dihydroxypropanoic, 2-(4-methoxyphenoxy) propanoic, 2-hydroxybutyric, 2,4-dihydroxybutyric, 2-methylbutanoic, Isovaleric, Methacrylic, Tiglic, Angelic, 3-methyl-2-butenoic, Pyruvic, 2-Oxobutyric, 3-oxobutanoic, Levulinic, Oxalic, Malonic, Succinic, Glutaric, Fumaric, Maleic, Methylsuccinic, Malic, Tartaric, 2-hydroxyglutaric, Ketoglutaric, Citraconic, Mesaconic, Itaconic, Citric, Aspartic, Glutamic, Pyroglutamic, Nicotinic, 2-Furoic, Benzoic, 3-hydroxybenzoic, 4-hydroxybenzoic, 2,5-dihydroxybenzoic, 3,4-dihydroxybenzoic, 3,4,5-Trihydroxybenzoic, 1,2,4-trihydroxybenzoic, Vanillic, Phytic, Phosphoric, Quinic, Caffeic, Ferulic, 3-(4-Hydroxy-3-methoxyphenyl)-2-propenoic, p-coumaric, o-coumaric, 4-methoxycinnamic, 3,4-dimethoxycinnamic, 3,4,5-trimethoxycinnamic, 3-caffeoylquinic, 4-caffeoylquinic, 5-caffeoylquinic, 3-feruloylquinic, 4-feruloylquinic, 5-feruloylquinic, 3,4-dicaffeoylqunic, 3,5-dicaffeoylqunic, 4,5-dicaffeoylqunic, p-coumaroylquinic, caffeoylferuoylqunic. The exact concentration of a specific acid within a given coffee source depends on the coffee species selected, the growing and harvesting conditions, and the coffee source preparation processes described above.

Coffee sources have been found to contain varying levels of acids depending on their form. For example, green coffee has been found to contain approximately 11% total acid by weight, roasted coffee has been found to contain approximately 6% total acid content by weight, and instant coffee has been found to contain approximately 16% total acid content by weight.

### C. COFFEE SOURCE COMPONENT

A coffee source component is defined as a taste contributing acid present within a given coffee source. As used herein the term “taste contributing” is defined as an acid contained within the coffee source that is perceptible by taste at a concentration in water that is identical to the concentration of the acid in the target coffee. Perceptible by taste is defined herein as modifying the sensory perception of one or more of the following flavor characteristics: sweet, salty, bitter, winey, acidy, mellow, bland, sharp, harsh, pungent, and the like. In addition, a taste contributing acid is an acid whose concentration exhibits at least one of the following phenomenon: a roast effect; a coffee species effect; and a coffee region of origin effect.

As used herein the term roast effect is defined as the existence of a relationship between the concentration of the acid in a roasted coffee source and the roasting conditions selected. One skilled in the art will appreciate that roasting conditions are generally recognized as time, heat input and moisture. One skilled in the art will also appreciate that the roasting conditions selected for a given coffee source can be characterized by roast time, roasting equipment, and a Hunter L* color. As used herein, color differences are defined in terms of readings measured on a Hunter calorimeter and specifically the values L*, a* and b* derived from the Hunter CIE scale. See pages 985-95 of R. S. Hunter, “Photoelectric Color Difference Meter,” J. of the Optical Soc. of Amer., Volume 48, (1958), herein incorporated by reference.

As used herein, the term coffee species effect is defined as an acid having a concentration in a coffee source of one coffee species, subjected to a given set of growing, harvesting, and processing conditions, that is different from the concentration in a different coffee species, subjected to identical growing, harvesting, and processing conditions. As used herein, the term coffee region of origin effect is defined as an acid having a concentration that is dependent on the coffee growing, harvesting, processing, fermentation, preparation, handling and/or storage processes.

The presence of a given coffee source component, and its corresponding concentration within a coffee source, is a function of many factors. The factors vary depending on the specific coffee source selected. Most notable among these, however, is the selection of a specific coffee species. Additionally, growing conditions such as rainfall amounts, temperature, fertilization, harvesting, handling, and storage of the coffee species contribute greatly to the presence and concentration of a given coffee source component. Moreover, subsequent processing and preparation of the coffee species may significantly impact coffee source component concentrations.

The coffee source component can exist within a coffee source in a variety of forms. Frequently the coffee source component is present in the acidic form of the taste contributing acid. As an acid, the coffee source component exists in both the associated and disassociated forms of the acid. However, it has been found that in the present invention suitable coffee source components may also exist as salts of the taste contributing acid.

### D. COFFEE SOURCE COMPONENT PROFILE

A Coffee source component profile is defined as the concentration of coffee source components present within a given coffee source. The coffee source component profile represents the coffee source component concentration at a pH value of 14, in the completely dissociated form of the acid. The coffee source component profile can take the form of a graph, a table, or some other suitable visual representation showing the existence and concentrations of coffee source components.

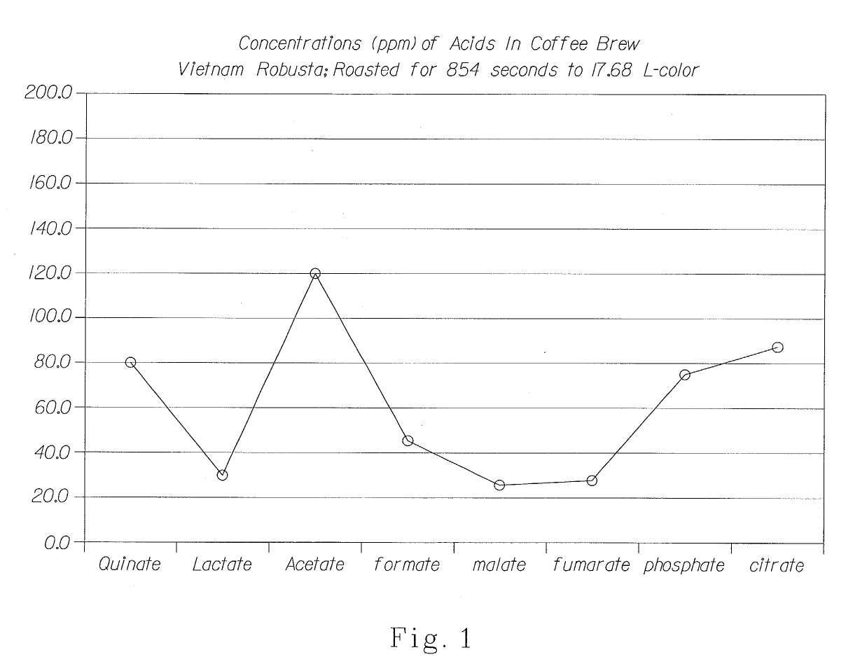

Table 1 is a tabular representation of the coffee source component profile of a roast and ground coffee source (Vietnam robusta, roasted for 854 seconds on a Thermalo batch roaster, to a Hunter L-color of 17.68). FIG. 1 is a graphical representation of the same coffee source component profile.

TABLE 1
Vietnam robusta, roasted for 854 seconds on a Thermalo
batch roaster to a Hunter L-color of 17.68

| Coffee Source | |
|---|---|
| Component | Concentration |
| (Anionic Form) | (ppm) |
| Quinate | 79 |
| Lactate | 30 |
| Acetate | 119 |
| Formate | 45 |
| Malate | 24 |
| Fumarate | 27 |
| Phosphate | 77 |
| Citrate | 85 |

### E. TARGET COFFEE, TARGET COFFEE COMPONENT, AND TARGET COFFEE COMPONENT PROFILE

As used herein the term “target coffee” is defined as a target coffee beverage or composition. The target coffee comprises a coffee element. The target coffees of the present invention may optionally contain additional elements, such as foaming agents, mouthfeel enhancing agents, flavorants, creamy components, inert fillers and carriers, sweetening agents, and the like.

The coffee element of the target coffee is derived from a plant of the Family Rubiaceae, Genus Coffea, from a given region of origin. The coffee element of the target coffee can be in a variety of forms including, but not limited to, cherries, beans, leaves, and bark, and mixtures thereof. Additionally, the coffee element can take the form of soluble coffee, roast and ground, roasted whole bean, green coffee, and extracts of coffee via aqueous, super-critical fluid, and organic solvent extraction processes. The coffee element of the target coffee may also exist as a mixture of two or more of the aforementioned forms. The coffee element may be caffeinated, decaffeinated, or a blend of both.

It has been found that the coffee element of the target coffee contains one or more of the following acids: Formic, Acetic, Propanoic, Butanoic, Pentanoic, Hexanoic, Heptanoic, Octanoic, Nonanoic, Decanoic, Palmitic, Crotonic, Isocrotonic, Hydroxyacetic, Isobutyric, Lactic, 3-hydroxypropanoic, Glyceric, 2,3-dihydroxypropanoic, 2-(4-methoxyphenoxy) propanoic, 2-hydroxybutyric, 2,4-dihydroxybutyric, 2-methylbutanoic, Isovaleric, Methacrylic, Tiglic, Angelic, 3-methyl-2-butenoic, Pyruvic, 2-Oxobutyric, 3-oxobutanoic, Levulinic, Oxalic, Malonic, Succinic, Glutaric, Fumaric, Maleic, Methylsuccinic, Malic, Tartaric, 2-hydroxyglutaric, Ketoglutaric, Citraconic, Mesaconic, Itaconic, Citric, Aspartic, Glutamic, Pyroglutamic, Nicotinic, 2-Furoic, Benzoic, 3-hydroxybenzoic, 4-hydroxybenzoic, 2,5-dihydroxybenzoic, 3,4-dihydroxybenzoic, 3,4,5-Trihydroxybenzoic, 1,2,4-trihydroxybenzoic, Vanillic, Phytic, Phosphoric, Quinic, Caffeic, Ferulic, 3-(4-Hydroxy-3-methoxyphenyl)-2-propenoic, p-coumaric, o-coumaric, 4-methoxycinnamic, 3,4-dimethoxycinnamic, 3,4,5-trimethoxycinnamic, 3-caffeoylquinic, 4-caffeoylquinic, 5-caffeoylquinic, 3-feruloylquinic, 4-feruloylquinic, 5-feruloylquinic, 3,4-dicaffeoylqunic, 3,5-dicaffeoylqunic, 4,5-dicaffeoylqunic, p-coumaroylquinic, caffeoylferuoylqunic. The exact concentration of an given acid within a the coffee element of the target coffee depends on the coffee species selected, the growing and harvesting conditions, and coffee element preparation processes described above.

The target coffee component profile is defined as the concentration of target coffee components present within the coffee element of the target coffee. The target coffee component profile can be represented by a graph, a table, or some other suitable visual representation showing the existence and concentrations of target coffee components.

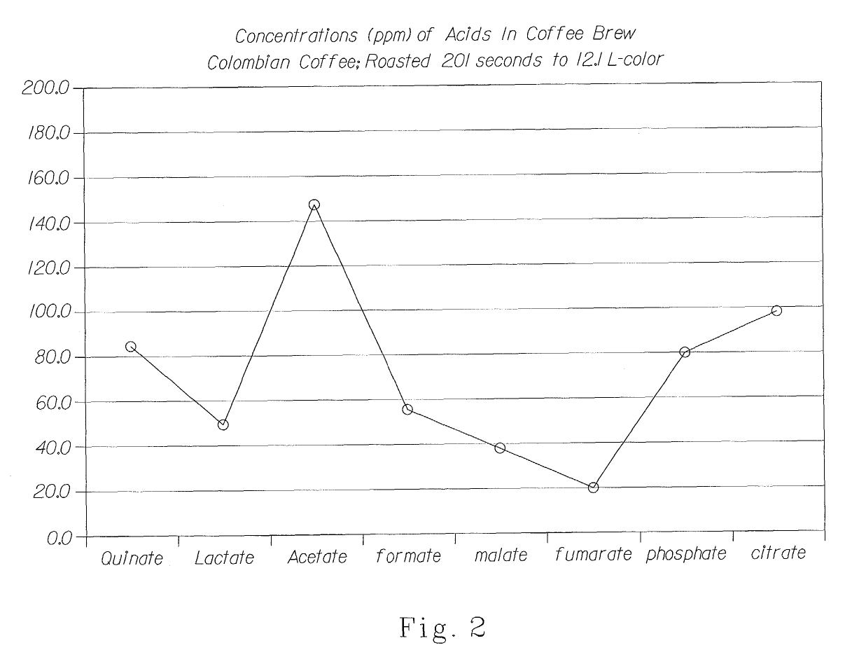

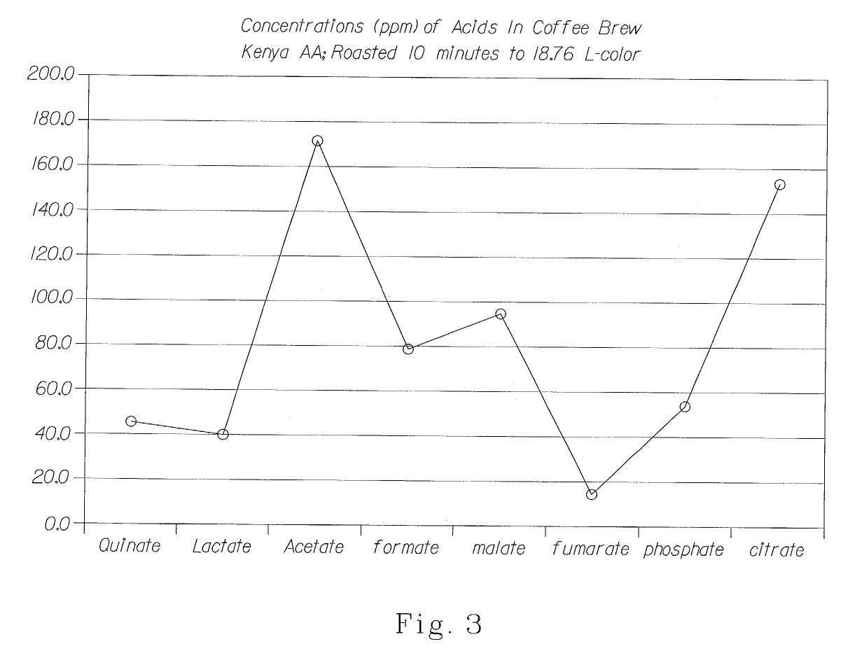

In one embodiment of the present invention the coffee element is a Colombian arabica, roasted for 201 seconds on a Thermalo batch roaster, to a Hunter L-color of 12.1. FIG. 2 is a graphical representation of the Columbian Arabica's target component profile. In another embodiment of the present invention the coffee element is a Kenya AA (arabica), roasted on a Jabez Burns laboratory roaster for 10 minutes, to a Hunter L-color of 18.76. The target component profile is shown in FIG. 3.

In another embodiment of the present invention a coffee source is provided that is a brewed roast and ground coffee that has been held at 185° F. for six hours. In this embodiment the coffee element of the target coffee is the same coffee immediately following brewing, prior to the onset of any significant aging processes.

### F. COFFEE SOURCE COMPONENT MODIFIER

A coffee source component modifier is defined as a compound, or combination of compounds, that adjusts the perceptible concentration of one or more coffee source components. In solution, an acid can exist entirely in an associated form, entirely in a dissociated form, or as a combination of the two. The proportion of a given acid that exists in its associated and dissociated states is, in part, a function of the equilibrium constant for the given acid (i.e., the pKₐ). Acceptable coffee source component modifiers include: sodium, magnesium, potassium, hydrogen, calcium, and ammonium cations, in combination with hydroxide, carbonate, bicarbonate, gluconate, and sulfates.

The coffee source component modifier compounds can exist in a variety of forms. The coffee source component modifier may exist in a solution of water, or some other suitable aqueous medium. Moreover, the coffee source component modifier can exist in non-aqueous solutions (e.g., oil and glycerin). Alternatively, coffee source component modifier may exist as one or more dry ingredients.

The coffee source component modifier can be combined with the coffee source in a variety of ways, depending on the nature and form of the coffee source and the coffee source component modifier. If the coffee source selected were a roast and ground coffee, the coffee source component modifier could exist in an aqueous solution that is sprayed onto, or mixed with, the roast and ground coffee. Alternatively, the coffee source component modifier could exist in a dry state, and be mixed with the roast and ground coffee source in a coffee composition. When the coffee composition is transformed into a coffee beverage, the coffee source component modifier would then act to adjust the perceptible concentration of the coffee source component in the method described. A coffee source component modifier existing in solution could also be applied (e.g., by spraying or mixing) to a roasted whole bean, green coffee bean, liquid coffee extract, soluble coffee, or other form of a coffee source (e.g., cherries, leaves, and the like). The same is true for a coffee source component modifier existing in a dry state. The coffee source component modifier can exist in any suitable form in an intermediate state of the final, consumable coffee beverage. The form of the coffee source component modifier is only limited by the need to exist in a state capable of adjusting the perceived concentration of the coffee source component, in the final, consumable form of the coffee beverage.

Coffee source component modifiers that are a combination of two or more suitable compounds can be combined with the coffee source together or separately. Additionally, multi-compound component modifiers can exist in different states (e.g., in solution and a dry state) so long as they are capable of adjusting the perceived concentration of the coffee source component, in the final, consumable form of the coffee beverage.

The coffee source component modifiers of the present invention also need not be applied directly to the coffee source to be effective. The coffee beverages and coffee compositions of the present invention may include additional ingredients, such as foaming agents, mouthfeel enhancing agents, flavorants, creamy components, inert fillers and carriers, sweetening agents, and the like. The coffee source component modifiers may be combined with any of these additional ingredients, in a suitable form, such that they are capable of adjusting the perceived concentration of the coffee source component, in the final, consumable form of the coffee beverage.

### G. SUPPLEMENTAL COFFEE SUOURCE COMPONENT

A supplemental coffee source component is defined as a taste contributing acid. Where the target coffee is a non-aged or less-aged version of the coffee source, the supplemental coffee source component will be a taste contributing acid that corresponds to the taste contributing acid of the coffee source component, though it may exist in the same or a different form of the acid. Where the target coffee is not a non-aged or less-aged version of the coffee source, the supplemental coffee source component may be any taste contributing acid preferred in the target component profile.

The supplemental coffee source component can exist in either the acidic form of the taste contributing acid (e.g., Citric Acid; Malic Acid; Formic Acid; Fumaric Acid; Phosphoric Acid; 2-Furoic Acid; Lactic Acid; Acetic Acid.), or as a salt of the taste contributing acid (e.g., Mono-, Di-, or Tri-Sodium Citrate; Mono-, Di-, or Tri-Potassium Citrate; Mono-, or Di-Sodium Malate; Mono- or Di-Potassium Malate; Sodium Formate; Potassium Formate; Mono- or Di-Sodium Fumarate; Mono- or Di-Potassium Fumarate; Mono-, Di-, or Tri-Sodium Phosphate; Mono-, Di-, or Tri-Potassium Phosphate; Sodium Furoate; Potassium Furoate; Sodium Lactate; Potassium Lactate).

Though the supplemental source component may be any of the taste contributing acids, preferred taste contributing acids are the acids of the following anions: Quinate, Lactate, Acetate, Formate, 2-Furoate, 3-Methyl Malate, Citramalate, Hydroxyglutarate, Glutarate, Malate, Citraconate, Maleate, Mesaconate, Oxalate, Fumarate, Phosphate and Citrate.

The supplemental coffee source components of the present invention may exist in a variety of forms. The supplemental coffee source component may exist in a solution of water, or some other suitable aqueous medium. Moreover, the supplemental coffee source component can exist in non-aqueous solutions (e.g., oil and glycerin). Alternatively, supplemental coffee source component may exist as one or more dry ingredients.

The supplemental coffee source component can be combined with the coffee source in a variety of ways, depending on the nature and form of the coffee source and the supplemental coffee source component. If the coffee source selected were a roast and ground coffee, the supplemental coffee source component could exist in an aqueous solution that is sprayed onto, or mixed with, the roast and ground coffee. Alternatively, the supplemental coffee source component could exist in a dry state, and be mixed with the roast and ground coffee source in a coffee composition. When the coffee composition is transformed into a coffee beverage, the supplemental coffee source component would then act to supplement the total concentration of the corresponding coffee source component in the method described herein.

A supplemental coffee source component existing in solution could also be applied (e.g., by spraying or mixing) to a roasted whole bean, green coffee bean, liquid coffee extract, soluble coffee, or other form of a coffee source (e.g., cherries, leaves, and the like). The same is true for a supplemental coffee source component existing as a dry ingredient. The supplemental coffee source component can exist in any suitable form, in an intermediate state of the final, consumable coffee beverage. The exact form of the supplemental coffee source component is only limited by the need to exist in a state capable of supplementing the total concentration of the corresponding coffee source component, in the final, consumable form of the coffee beverage.

Supplemental coffee source components that are a combination of two or more suitable compounds can be combined with the coffee source together or separately. Additionally, multi-compound supplemental coffee source components can exist in different states (e.g., in solution and a dry state) so long as they are capable of supplementing the total concentration of the corresponding coffee source component, in the final, consumable form of the coffee beverage.

The supplemental coffee source components of the present invention need not be combined with the coffee source directly to be effective. The coffee beverages and coffee compositions of the present invention may include additional ingredients, such as foaming agents, mouthfeel enhancing agents, flavorants, creamy components, inert fillers and carriers, sweetening agents, and the like. The supplemental coffee source components may be combined with any of these additional ingredients, in a suitable form, such that they are capable of supplementing the total concentration of the corresponding coffee source component, in the final, consumable form of the coffee beverage.

### H. PERCEPTIBILITY OF ACIDS

The Applicants have observed that the individual acids found in coffee each have an associated flavor note. It has also been observed by Applicants that specific combinations of these acids exhibit characteristic flavors based on the specific combination of acids and their associated flavor notes. Though the ability to perceive the associated flavor note for a given acid in solution by the sensory perception of taste is a function of its concentration, it is not necessarily directly correlated to the acid's total concentration. Not intended to be limited by theory, Applicants believe that the sensory perception of taste is only capable of perceiving an acid in its associated form. Therefore, the portion of the total acid concentration in a dissociated state does not directly contribute to the taste perception of an acid's associated flavor note, nor the perception of characteristic flavors based on the combination of associated flavor notes.

It is understood by the ordinarily skilled artisan that acids exist in both an associated and dissociated state when present in aqueous solutions. The molecular equilibrium is expressed simply as:

HA ⇄ H⁺ + A⁻

| | |
|---|---|
| Associated Form | Dissociated Forms |

The anions may also be found in solutions containing salts of the acid. For a more detailed discussion of the mathematical relationships for this equilibrium see Quantitative Chemical Analysis, 4^{th} Edition, by Daniel C. Harris, W. H. Freeman and Company, 1995, pp. 217-270, herein incorporated by reference. The dissociation constant Kₐ for a given acid expresses the relationship of the three components of the equilibrium in terms of their molar concentrations:

Kₐ=([H⁺][anions])/[HA]

The hydrogen ion concentration is expresses by the symbol pH. The Henderson-Hasselbach equation relates the pH of a solution to the acid's Kₐ value:

pH=log([anions]/[HA])−log Kₐ

The negative logarithm of the dissociation constant is known as the pKₐ value in a similar manner to the pH value, which is the negative logarithm of the hydrogen ion:

pH−pKₐ=log([anions]/[HA])

Changes in the pH of a solution result in different concentrations of a given acid's associated and dissociated forms, depending on that given acid's pKₐ value. Therefore, as the pH value of a solution changes so does the ability to perceive the taste an acid's characteristic flavor note, or the characteristic flavor of a combination of specific flavor notes.

### I. COFFEE AGING

Once a coffee is in liquid form, either by brewing, extracting, or other similar processes, it begins to undergo aging process. As used herein, the term “aging” is defined as the processes whereby the flavor profile of a coffee changes in response to an increase in acidity. The aging process typically imparts a bitter and/or sour taste to coffee. The art suggests that the increase in acidity resulting from the aging process is caused by a variety of factors, including hydrolysis of celluloses contained within the coffee; oxidation of aldehydes to acids; hydrolysis of chlorogenic acids to caffeic and quinic acids; and conversion of quinic acid lactones to quinic acid.

Not intending to be limited by theory, Applicants believe that the evolution of additional quantities of acidic species existing in coffee prior to aging, and/or the evolution of additional acidic species not present prior to aging, increases the total hydronium ion concentration ([H⁺]) within the coffee. As the total hydronium ion concentration in solution increases the equilibrium between any given acid's perceptible and imperceptible concentration shifts in favor of the perceptible concentration. The extent of the shift is a function of the pKₐ of the given acid and the overall change in the pH value of the coffee.

More specifically, it is believed by Applicants that as additional quantities of the acidic species existing in coffee prior to aging are generated, and/or additional acidic species not present prior to aging are generated, the associated flavor notes of these acids come to dominate the overall flavor profile of the coffee. The exact nature and extent of the change in a flavor profile resulting from the aging process depends on several factors. These factors include, but are not limited to, duration of aging, temperature of aging, initial pH, and the identity and quantity of the additional acidic species generated. Moreover, the associated flavor notes for the generated acids play a role, as do their perceptibility by the sensory perception of taste and the interrelatedness of the total hydronium ion concentration in solution to the perceptible concentration of all acids present in the coffee.

The Applicants have further discovered that it is possible to overcome the dispreferred flavor effects of the aging process employing processes whereby the flavor profile of an aged coffee (i.e., a coffee source) is adjusted to approximate or mimic the flavor profile of a corresponding, non-aged coffee (i.e., a target coffee). It has also been discovered that the flavor profile of an aged coffee may be adjusted so as to approximate or mimic the flavor profile of a non-corresponding coffee as well.

Applicants have found that by using a flavor profile modifier the equilibrium between the perceptible and imperceptible concentrations of the acids in the aged coffee can be forced to shift back in favor of the non-perceptible concentration. The flavor profile of the corresponding, non-aged coffee (or if preferred a non-corresponding coffee) can then be mimicked by the addition of sufficient amounts of the appropriate, relevant acids in the target profile.

### J. PROFILE MIMICKING AND ADJUSTMENT

Each acid in coffee has an associated flavor note. Specific combinations of coffee acids will exhibit a characteristic flavor profile based on the combination of associated flavor notes and the perceptible concentration of each of the acids in that combination. Therefore, flavor profiles can be identified for specific coffees of interest wherein the flavor profile for that coffee is a function of the concentration of at a least a portion of the acids in that coffee. Mathematically, the flavor profile for a specific combination of acids (i.e., a given coffee) is expressed as the relative ratio of the concentrations of the acids to each other within that combination.

[A₁]:[A₂]: . . . :[Aₙ], where [Aₓ] is the total concentration of a given acid.

At a given pH and depending on the pKa of the specific acid, a portion of the concentration of a specific acid will be in a form perceptible by taste (i.e., the associated form of the acid). And therefore, it has been found that what imparts the perceived characteristic flavor of a given profile is the combination of perceptible concentrations of the acids within that combination and their relative ratios to each other.

[HA₁]:[HA₂]: . . . :[HAₙ], where [HAₓ] is the perceptible concentration of acid X.

Applicants have discovered that the flavor profile of a first coffee (i.e., a coffee source) may be readily adjusted so as mimic the flavor profile of a second coffee (i.e., a target coffee). As used herein, the term “mimic” is defined as approximating, imitating, or resembling in such a way as to deliver a substantially similar characteristic flavor. In order for a coffee source to mimic the characteristic flavor profile of a target coffee the coffee source must be adjusted in such a way that the total concentration of relevant acids in the adjusted coffee have substantially the same relative ratios to each other as the corresponding relevant acids in the target coffee. Additionally, the concentrations of relevant acids in the adjusted coffee must be sufficiently large so that the perceptible concentrations of relevant acids in the adjusted coffee (i.e., the associated form of the acid) are at least as great as the perceptible concentrations of the corresponding acids in the target coffee if the two coffees (i.e., the adjusted coffee source and the target coffee) were to be measured at the same pH. These conditions are expressed as follows:

([A₁]:[A₂]: . . . :[Aₙ])_{first coffee}≈([A₁]:[A₂]: . . . :[Aₙ])_{second coffee}

and

[HA₁]_{first coffee}≧[HA₁]_{second coffee}

[HA₂]_{first coffee}>[HA₂]_{second coffee}

[HAₙ]_{first coffee}>[HAₙ]_{second coffee}

As used herein, the term “corresponding acid” is defined as the acid of the same species. For example, if the acid of interest in a first coffee were malic acid then the corresponding acid in the second coffee would also be malic acid.

It will be appreciated by those skilled in the art upon reviewing the disclosure herein that although all of the acids commonly found in coffee have an associated flavor note, not all of these acids will necessarily make a significant and/or preferred contribution to the characteristic flavor profile of a given coffee. Applicants have found that of the acids typically present in coffee only a select set of those can be considered relevant acids. As used herein, the term “relevant acid” is defined as an acid that would be perceptible by taste at a concentration in water that is equal to the concentration of the acid in the target coffee and, has a concentration that varies according to the coffee roasting conditions selected, the coffee region of origin, or the coffee species. Similarly stated, the term “relevant acid” is defined herein as one of the taste contributing acids found within coffee that would be perceptible by taste at a concentration in water that is equal to the concentration of the acid in the target coffee and exhibits one or more of the following phenomenon: a coffee roasting effect, a coffee species effect, or a coffee region of origin effect.

It will further be appreciated by the ordinarily skilled artisan in view of the disclosure herein, that not all of the coffee acids that satisfy the heretofore mentioned conditions (i.e., perceptibility in water, roast effect, species effect, and region of origin effect) would necessarily be required to sufficiently mimic a given flavor profile. Factors including, but not limited to, cost, availability, ease of use, manufacturing complexity, classification as a food grade acid by an appropriate regulatory agency such as the U.S. Food and Drug Administration, and commercially significant consumer preference differences between subtly different profiles need to be considered when selecting the exact number and species of relevant acids to be used in the mimicking of a given flavor profile.

The Applicants have found that the ability to accurately measure changes in the concentration of a given acid within a coffee, analytically, is greater than the ability to measure a comparable change in concentration by the sensory perception of taste. The Applicants have also found that how closely the flavor profile of a first coffee needs to mimic the flavor profile of a second coffee to provide a suitable, consumer acceptable approximation of the flavor profile is a function of the ability to “taste” the difference between the two profiles, more than the ability to analytically measure the difference. If the concentrations of relevant acids in the first coffee have substantially the same relative ratios to each other as the corresponding acids in the second coffee then the first flavor profile is said to sufficiently mimic the second flavor profile. The acceptable variation between the relative ratios of relevant acids in a first coffee and the relative ratios of corresponding acids in a second coffee is a function of the particular coffees selected and the ability to perceive a particular acid by the sensory perception of taste.

Variations in the relative ratio between acids in a first coffee and the corresponding acids in a second coffee in the range of from about 50% above to about 50% below the relative ratio are acceptable, variations in the relative ratio between acids in a first coffee and the corresponding acids in a second coffee in the range of from about 40% above to about 40% below the relative ratio are preferred, variations in the relative ratio between acids in a first coffee and the corresponding acids in a second coffee in the range of from about 30% above to about 30% below the relative ratio are more preferred, variations in the relative ratio between acids in a first coffee and the corresponding acids in a second coffee in the range of from about 20% above to about 20% below the relative ratio are yet more preferred, variations in the relative ratio between acids in a first coffee and the corresponding acids in a second coffee in the range of from about 10% above to about 10% below the relative ratio are yet more preferred, variations in the relative ratio between acids in a first coffee and the corresponding acids in a second coffee in the range of from about 5% above to about 5% below the relative ratio are most preferred.

Discussing these concepts by way of example, assume a first coffee (e.g., a coffee source) comprising ten relevant acids (A₁, A₂, . . . , A₁₀). Assume a second coffee source (e.g., a target coffee) comprising the same (i.e., corresponding) ten acids (A₁, A₂, . . . , A₁₀), although with different concentrations. The relative ratios of the ten relevant acids in the first coffee are (1:2:3:1:3.5:4:2:1.5:0.7:1). The relative ratios of the ten relevant acids in the second coffee are (1:3:2:2:2.5:3:1:2.5:1.2:0.5). In order to mimic the flavor profile of the target coffee a sufficient amount of a supplemental, corresponding acid would have to be added to the coffee source such that the resulting coffee (i.e., the coffee source combined with the supplemental acids) would have the same relative ratios of relevant acids to each other, within the acceptable variation limits described herein, as exists in the target coffee.

One preferred process of the present invention comprises the following steps. First, a coffee source is selected and coffee source components are identified. A coffee source component profile is then acquired by the method described herein showing the total concentration of the coffee source components. The same process is done for the coffee element of a target coffee, though it will be appreciated upon viewing the disclosure herein that the step of determining the target coffee's flavor profile does not have to be contemporaneous with the acquisition of the flavor profile of the coffee source.

Subsequently, the concentrations of the coffee source components in the coffee source component profile are compared to the concentrations of the corresponding target coffee components in the target coffee component profile. The concentrations of the coffee source components are then supplemented with corresponding supplemental coffee source components. The supplemental coffee source components add sufficient quantities of the corresponding taste contributing acids to a coffee portion of the coffee beverage or composition, such that the relative concentration ratios of the resulting coffee component (e.g., the sum of the coffee source component and a corresponding supplemental coffee source component) approximates the relative concentration ratios of the target coffee components, within acceptable variances. Additionally, the supplemental coffee source components add sufficient quantities of the corresponding taste contributing acids to ensure that the perceptible concentration of the relevant acids in the resulting coffee is at least as great as the perceptible concentration of the corresponding relevant acids in the target profile.

This ensures that if the resulting coffee and the target coffee were measured at the same pH value they would have a substantially similar perceived flavor profile by the sensory perception of taste, thereby mimicking the flavor profile of the target coffee and delivering the same perceived flavor note and intensity of the acid.

The coffee beverage or composition comprising the resulting coffee can then be prepared in any consumer preferred fashion (e.g., as a cappuccino or latte, black, chilled, as a flavorant in another food or beverage product, etc.). If the pH of the coffee beverage or composition comprising the resulting coffee is within an acceptable range of the pH value of the coffee element of the target coffee, then the resulting coffee will have a flavor profile that behaves substantially similarly to the flavor profile of the coffee element of the target coffee. The concentration of the associated forms of the acids in each will approximate or mimic each other and behave similarly in response to changes in pH values.

A preferred pH range over which the resulting flavor profile behaves substantially similarly to the flavor profile of the coffee element of the target coffee is from about 2 pH units above to about 2 pH units below the pH value of the coffee element of the target coffee. A range of from about 1 pH unit above to 1 pH unit below is more preferred. A range of from about 0.5 pH units above to 0.5 pH units below is yet more preferred. A range of from about 0.2 pH units above to 0.2 pH units below is yet more preferred. A range of from about 0.1 pH units above to 0.1 pH units below is most preferred. The pH value of all substances is measured at standard temperature and pressure, herein after referred to as STP (25° C., 760 mmHg).

### K. PROFILE MIMICKING AND ADJUSTMENT OF AGED COFFEES

As described herein Applicants have found it is possible to overcome the dispreferred flavor effects of the aging process employing processes whereby the flavor profile of an aged coffee (i.e., a coffee source) is adjusted to approximate or mimic the flavor profile of the corresponding, non-aged coffee (i.e., a target coffee). It has also been discovered that the flavor profile of an aged coffee may be adjusted so as to approximate or mimic the flavor profile of a non-corresponding coffee as well.

In one embodiment of the present invention a coffee source is provided in the form of a brewed roast and ground coffee. The coffee source component profile of the freshly brewed roast and ground coffee is determined and retained for future use as a target coffee component profile. Upon brewing, the brewed coffee source begins to age. Applicants have found that the speed of the aging process is highly correlated to temperature (e.g., coffees will age faster at higher temperatures). At a point prior to consumption the coffee source component profile of the aging coffee is determined according to the method described herein. The coffee source component profile of the aging coffee is compared to a target coffee component profile, which in this embodiment is the coffee source component profile of the freshly brewed roast and ground coffee. A suitable coffee source component modifier is selected and added to the aging coffee so as to shift the equilibrium in favor of the dissociated forms of the acids contained therein, thereby making the acids less perceptible to the sensory perception of taste. Sufficient amounts of suitable supplemental coffee source components are then added so as to appropriately mimic the flavor profile of the corresponding, non-aged coffee. It will be appreciated by the ordinarily skilled artisan upon reading the disclosure herein that the process of mimicking the target coffee could have occurred immediately prior to consumption, or alternatively could have occurred some period of time prior to consumption.

Even after the flavor profile of a non-aged coffee has been mimicked in an aged coffee the aging process continues. Applicants have discovered that the process of mimicking the flavor profile of a non-aged coffee, however, may be employed more than once. In another embodiment of the present invention a brewed roast and ground coffee source is provided that has a six hour hold-time. At a point 2 hours into the hold time of the aging coffee, a suitable coffee source component modifier is selected and added to the aging coffee so as to shift the equilibrium in favor of the dissociated forms of the acids contained therein, thereby making the acids less perceptible to the sensory perception of taste. Then sufficient amounts of suitable supplemental coffee source components are added so as to appropriately mimic the flavor profile of the corresponding, non-aged coffee. This process is repeated at a point four hours into the hold-time of the coffee. Though the aging of the coffee continues following the mimicking process, the starting point for aging is effectively reset to that of the fresh brewed coffee. Therefore, in the present embodiment a brewed coffee that is six hours old may be provided that has a flavor profile of a corresponding two hour old coffee. It will be appreciated by the ordinarily skilled artisan upon reading the disclosure herein that this process is not limited in the number of times it may be repeated.

Applicants have further discovered that it is possible to adjust the flavor profile of a coffee source in such a way as to acceptably approximate or mimic the flavor profile of a freshly brewed coffee over a period of time. The period of time may be defined as the acceptable hold-time of a given coffee, or alternatively may be defined as the period of time in which a certain amount of aging would occur in a given coffee source were left unadjusted.

In yet another embodiment of the present invention a concentrated liquid coffee extract is provided as a coffee source. The coffee source component profile of a freshly extracted coffee is determined and retained for future use as a target coffee component profile. Based on a previously determined understanding of how the flavor profile of the coffee source changes over time, developed from repeated flavor profile examinations, a suitable coffee source component modifier is selected and added to the aging coffee so as to shift the equilibrium in favor of the dissociated forms of the acids contained therein. This has the result of making the acids less perceptible to the sensory perception of taste. Then sufficient amounts of suitable supplemental coffee source components are added so as to appropriately mimic the flavor profile of the corresponding, non aged coffee over a period of time, which in the present embodiment is eight weeks.

As stated previously the target coffee may optionally be a non-aged, non-corresponding coffee. In yet another embodiment of the present invention a liquid coffee extract is provided as a coffee source. The coffee source component profile of a freshly brewed roast and ground coffee is determined and retained for future use as a target coffee component profile. A suitable coffee source component modifier is selected and added to the aging coffee so as to shift the equilibrium in favor of the dissociated forms of the acids contained therein. This has the result of making the acids less perceptible to the sensory perception of taste. Then sufficient amounts of suitable supplemental coffee source components are added so as to appropriately mimic the flavor profile of the freshly brewed roast and ground coffee (i.e., non-corresponding, non aged coffee) over a period of time, which in the present embodiment is ten weeks.

### L. PREPARATION OF FLAVOURED COFFEE BEVERAGES AND COMPOSITIONS

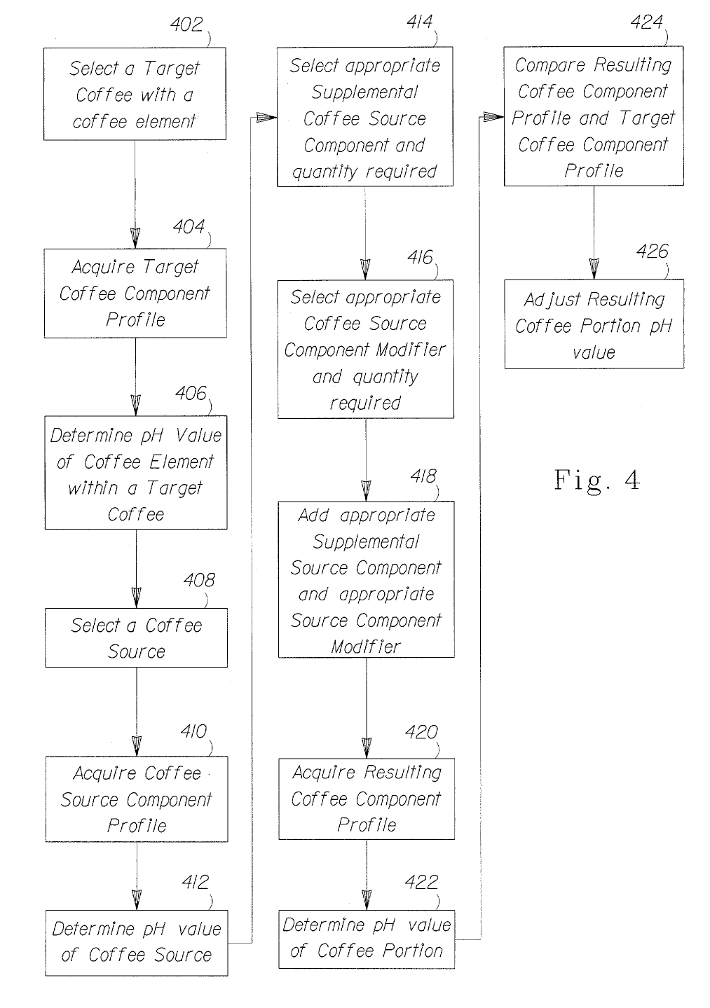

FIG. 4 is a flow diagram of the steps for the process of one embodiment of the present invention. Referring to the figure, step 402 is to select a target coffee comprising a coffee element. The coffee element can be in a variety of forms such as cherries, beans, leaves, and bark. Additionally, the coffee element can take the form of soluble coffee, roast and ground, roasted whole bean, green coffee, and extracts of coffee via aqueous, super-critical fluid, and organic solvent extraction processes. The coffee element can also be caffeinated, decaffeinated, or a blend of both.

The target coffee may optionally contain additional elements, such as foaming agents, mouthfeel enhancing agents, flavorants, creamy components, inert fillers and carriers, sweetening agents, and the like.

Step 404 is to acquire the target coffee component profile showing the concentration of the target coffee components. Step 406 is to determine the pH value of the coffee element of the target coffee. The pH value is measured at standard temperature and pressure. One skilled in the art will appreciate that though the coffee element of the target coffee might have a given pH value, the pH value of the target coffee as a whole might be different, depending on the presence of additional elements.

Step 408 is to select a suitable coffee source. The coffee source can be in a variety of forms such as cherries, beans, leaves, and bark. Additionally, the coffee source can take the form of soluble coffee, roast and ground, roasted whole bean, green coffee, and extracts of coffee via aqueous, super-critical fluid, and organic solvent extraction processes. The coffee source can also be caffeinated, decaffeinated, or a blend of both. Additionally, one of ordinary skill in the art upon viewing the disclosure herein will appreciate that the coffee source and target may be the same coffee, differing only in how long they have been aged. Step 410 is to acquire the coffee source component profile showing the concentration of the coffee source components. Step 412 is to determine the pH value of the coffee source. The pH value is measured at standard temperature and pressure.

Step 414 is to select the appropriate supplemental coffee source component(s) and the amount required to adjust the coffee source component profile. The quantity of supplemental coffee source component(s) required is determined by the relative concentration ratio of target coffee components. A sufficient amount of a supplemental coffee source component is added such that the relative concentration ratios of the resulting coffee components (e.g., the sum of the coffee source component and a corresponding supplemental coffee source component) approximates the relative concentration ratios of the target coffee components, within acceptable variances. Additionally, the supplemental coffee source component adds sufficient quantities of the corresponding taste contributing acids to ensure that the perceptible concentration of the relevant acids in the resulting coffee is at least as great as the perceptible concentration of the corresponding relevant acids in the target profile. This ensures that if the resulting coffee and the target coffee were measured at the same pH value they would have a substantially similar perceived flavor profile by the sensory perception of taste, thereby mimicking the flavor profile of the target coffee and delivering the same perceived flavor note and intensity of the acid.

Step 416 is to select the appropriate coffee source component modifier and the amount required to adjust the perceptible concentration of the resulting coffee source component. The amount of coffee source component modifier required depends, in part, on the coffee source and the coffee element of the target coffee selected.

Step 418 is to formulate the coffee portion by combining the selected supplemental coffee source components and the coffee source component modifier with the coffee source. As described above, the supplemental coffee source component and coffee source component modifier can exist and be applied in a variety of forms. Moreover, the application of the supplemental coffee source components and coffee source component modifier does not have to occur at the same moment. Additionally, the components can be applied at any point in the preparation of the coffee beverages or compositions of the present invention. Or, during the formation of any intermediate product used in the creation of the coffee beverages or compositions of the present invention.

Depending on the coffee source selected the supplemental coffee source components and the coffee source component modifier can be delivered to the coffee beverages or compositions of the present invention: by a machine or other dispensing apparatus; by impregnating the ingredients in the lining of a cup; by impregnating the ingredients in a filter; by pre-measured tablet or packet; and, through the water used in various stages of product preparation (e.g., the roasting quench used to cool a post-roasted coffee, or the water used to create the final, consumable coffee beverage). The components and modifiers can be introduced via spraying, coating, soaking, co-mixing, or other suitable method.

If the coffee source is an agglomerated instant coffee product, components and modifiers of the present invention could be combined with the coffee source via part of an agglomeration binding solution (e.g., carbohydrate and/or starch, water, or other suitable surfactant); in a dry form that is part of the agglomeration; sprayed onto the agglomerated particle in liquid form; or, coated onto an otherwise physically inert ingredient (e.g., sucrose, maltodextrin).

Step 420 is to acquire the resulting coffee component profile showing the total concentration of the resulting coffee source components. Step 422 is to determine the pH value of the coffee portion. The pH value is measured at standard temperature and pressure. Steps 424 and 426 require validating the results by comparing the resulting coffee component profile with the target coffee component profile and ensuring that the coffee portion is within an acceptable pH range of the coffee element of the target coffee.

One skilled in the art will appreciate that each and every step of the method described above is not required for every execution of the present invention. The exact sequence and number of steps required is dependent on the particular execution of the present invention.

### M. ANALYTICAL METHODS

Method for Determination of Coffee Components

The coffee components of the present invention are separated and quantified by Ion Chromatography (IC) utilizing alkaline anion-exchange with conductivity detection. The system is a Dionex DX 500 Ion Chromatograph comprising:

i) IP25 Isocratic Pump;

ii) EG40 Eluent Generator;

iii) Ion Pac ATC-1 anion-trap PN #37151;

iv) AS50 Autosampler;

v) LC30 Chromatography Oven;

vi) Ion Pac AS-1 IHC column (4 mm×20 cm) (PN 052960);

vii) Ion Pac AG-11-HC (PN 052962) guard column;

viii) CD20 Conductivity Detector; and,

ix) 4 mm ASRS-Ultra suppressor.

The chromatographic column consists of a 9-μm highly cross-linked macroporous ethylvinylbenzene-divinylbenzene resin core with 70-nm diameter microbeads of anion-exchange latex attached to the surface. The mobile phase is electrolytically generated from distilled-deionized water by using a Dionex EG40 Eluent Generator and is characterized as follows:

1. Eluent A: 18 Mohm-cm Milli-Q water or better, filtered throughla 0.45 mm filter, degassed, and transferred to reservoir A with a continuous blanket of nitrogen.

2. Eluent B: Potassium Hydroxide Cartridge (EluGen EGC-KOH EluGen cartridge, Dionex Inc.)

Deionized water is delivered by the pump to the EluGen Cartridge in the EG40. DC current is applied to the EluGen Cartridge to produce potassium hydroxide eluent. The resulting mobile phase gradient is described in Table 2 below.

TABLE 2

| time (min) | [NaOH] (mM) | Ramp |
|---|---|---|
| 0 | 1 | |
| 15 | 1 | isochratic |
| 25 | 15 | linear |
| 35 | 30 | linear |
| 16 | 60 | linear |

The column is kept at a temperature of 32° C. The flow rate is 1.5 mL/min and the injection volume is 10 μL. The data collection time is 55 minutes at a data collection rate of 5 points per second.

The above described analytical method is further disclosed in Dionex Corporation Application Note 123, “Determination of Inorganic Anions and Organic Acids in Fermentation Broths” and, Dionex Corporation Application Note 25, “Determination of Inorganic Anions and Organic Acids in Non-Alcoholic Carbonated Beverages”, herein incorporated by reference.

The first step in the method for the identification, separation, and quantification of coffee components is to prepare an aqueous sample solution of the substance to be analyzed (coffee source, target coffee, or coffee portion). The aqueous sample solution must then be filtered to remove large suspended solids. A purified sample is then collected and analyzed using the above equipment.

By way of example, if the substance to be analyzed is a roast and ground coffee then first weigh 2.0 grams of R&G into a 100 ml volumetric flask. Add 50 ml of boiling HPLC water to the sample and boil on a hot plate for 10 minutes. Cool to room temperature and bring to volume with HPLC water. Then filter 2 ml through a 0.45 mm Nylon Membrane filter (acrodisc). Discard the first 1 ml and collect the second 1 ml in a sample vial and cap. Finally, analyze the purified sample using the above described equipment.

If the substance to be analyzed is a brewed coffee then filter approximately 2 ml through a 0.45 mm Nylon Membrane filter (acrodisc). Discard the first 1 ml and collect the second 1 ml in a sample vial and cap. Finally, analyze the purified sample using the above described equipment.

If the substance to be analyzed is a soluble coffee then weigh 1 gram of the soluble coffee into a 100 ml volumetric flask. Add 50 ml of boiling HPLC water to the sample. Swirl the solution to mix well, then cool and dilute to volume. Then filter 2 ml through a 0.45 mm Nylon Membrane filter (acrodisc). Discard the first 1 ml and collect the second 1 ml in a sample vial and cap. Finally, analyze the purified sample using the above described equipment.

If the substance to be analyzed is a coffee extract then it will need to be diluted in order to pass through the 0.45 mm Nylon Membrane filter (acrodisc). The extent of the dilution is dependent upon the viscosity of the particular sample to be analyzed. If the sample to be analyzed is in a form other than described above it will need to be prepared as outlined above. Samples that will not be analyzed shortly following preparation require refrigeration.

Calibration of the Ion Chromatography Method

One skilled in the art will appreciate that calibration is necessary to convert detector response to measures of concentration (e.g., parts per million, milligrams per liter, and the like). Calibration of the IC method is performed by preparing solutions of the free acids (when available as solids of sufficient purity) or of the sodium or potassium salts. Response factors (RF, ppm/peak area) were determined by a five level calibration for quinic, lactic, acetic, formic, malic, phosphoric and citric acids. Where the salts were used, gravimetric factors were applied such that the RF values corresponded to free acid concentration (ppm).

Quinic Acid

Quinic acid (Aldrich 77-95-2, 98% pure, FW=192.17 g/mol) was used. A primary stock solution was prepared by weighing 0.1015 g into a 100 mL volumetric flask. A secondary stock was prepared by 10-fold dilution. Five calibration solutions were made by successive 2-fold dilutions of the secondary stock. The fit was linear (r²=0.9998) over a 6 to 100 ppm range.

Lactic Acid

Sodium lactate (Sigma L-7022, approx. 98% pure, FW=112.06 g/mol) was dried overnight in a desiccator containing CaSO₄. A primary stock solution was prepared by weighing 0.1079 g into a 100 mL volumetric flask. A secondary stock was prepared by 10-fold dilution. Five calibration solutions were made by successive 2-fold dilutions of the secondary stock. The fit was linear (r²=0.9996) over a 5 to 85 ppm range.

Acetic Acid

Sodium acetate (Sigma S7545, 99.0% pure, FW=82.03 g/mol) was used. A primary stock solution was prepared by weighing 0.1035 g into a 100 mL volumetric flask. A secondary stock was prepared by 10-fold dilution. Five calibration solutions were made by successive 2-fold dilutions of the secondary stock. A quadratic fit (r²=0.9999) was preferred to a linear fit (r²=0.984) over the 5 to 75 ppm range.

Formic Acid

Sodium formate (Sigma S2140, 99.6% pure, FW=68.01 g/mol) was used. A primary stock solution was prepared by weighing 0.1007 g into a 100 mL volumetric flask. A secondary stock was prepared by 10-fold dilution. Five calibration solutions were made by successive 2-fold dilutions of the secondary stock. The fit was linear (r²=0.9990) over a 4 to 70 ppm range.

Malic Acid

Malic acid (Aldrich 617-48-1, 99+% pure, FW=134.09 g/mol) was used. A primary stock solution was prepared by weighing 0.1020 g into a 100 mL volumetric flask. A secondary stock was prepared by 10-fold dilution. Five calibration solutions were made by successive 2-fold dilutions of the secondary stock. A quadratic fit (r²=0.9999) was preferred to a linear fit (r²=0.985) over the 6 to 100 ppm range.

Phosphoric Acid

Potassium phosphate, monobasic (Aldrich 7778-77-0, 99% pure, FW=136.09 g/mol) was used. A primary stock solution was prepared by weighing 0.1020 g into a 100 mL volumetric flask. A secondary stock was prepared by 10-fold dilution. Five calibration solutions were made by successive 2-fold dilutions of the secondary stock. Fit was linear (r²=0.9999) over a 5 to 75 ppm range.

Citric Acid

Citric acid (Aldrich 77-92-9, 99+% pure, FW=192.12 g/mol) was used. A primary stock solution was prepared by weighing 0.1034 g into a 100 mL volumetric flask. A secondary stock was prepared by 10-fold dilution. Five calibration solutions were made by successive 2-fold dilutions of the secondary stock. A quadratic fit (r²=0.9999) was preferred to a linear fit (r²=0.989) over the 6 to 100 ppm range.

### N. EXAMPLES

The following examples further describe and demonstrate embodiments within the scope of the present invention. These examples are given solely for the purpose of illustration and are not to be construed as a limitation of the present invention, as many variations thereof are possible without departing from the invention's spirit and scope.

Preparation of Coffee Source Components and Coffee Source Component Modifiers

Stock 1 molar solutions are prepared for each of sodium hydroxide, potassium hydroxide, di-sodium malate, tri-potassium citrate, tri-sodium citrate, di-potassium phosphate, malic acid, citric acid, phosphoric acid, lactic acid, formic acid, and acetic acid. For each individual example, the appropriate materials were either pre-mixed and then added to the coffee source or added to the coffee source using VWR model 990A1925 and BIOHT model AR71005 pipettes.

### Example 1

A roast and ground coffee is prepared comprising 60% by weight of a first coffee and 40% by weight of a second coffee. The first coffee comprises a Central American Arabicas roasted to a Hunter color of 15.6 L. The second coffee is a blend of 75% arabicas and 25% robustas. The 75/25 arabica/robusta blend is roasted to a target Hunter color of 16.5 L. The first coffee and the second coffee are blended together and subsequently ground to an average particle size of 724 microns.

A coffee source comprising a liquid coffee extract is prepared from the roast and ground coffee above. An extraction column is filled with 6.5 kg of the prepared roast and ground coffee source. Suitable coffee extraction columns include, but are not limited to, continuous flow columns. Said columns are typically stainless steel vertical columns having a height-to-diameter ratio greater than or equal to 6:1 and a perforated top and bottom retainer to permit the transport of feed water while simultaneously keeping coffee granules between the retainers. Suitable columns can be obtained from Niro A/S of Soeborg, Denmark. The column is flushed with nitrogen and then extracted with distilled, dearated water at the rate of 1.8 liters/minute at 180° F. The extract is cooled to 85° F. after exiting the column. The extract has a solids level of 3.89% by weight.

The coffee source comprising a liquid coffee extract is diluted to 0.7% solids by weight using distilled water and a coffee source component profile is determined per the analytical method described herein. The coffee source component profile and relative concentration ratios are shown in Table 3.1.

TABLE 3.1

| Coffee Source | Malic | |
|---|---|---|
| Component | Acid | Citric Acid |
| Concentration, | 49.9 | 120.1 |
| ppm: | | |
| Relative Ratios | 1 | 2.41 |

The pH of the liquid extract coffee source is measured using an ORION model 290A pH meter. The pH is observed to be 5.062. The coffee source comprising a liquid coffee extract is heated in a MicroThermics Model 25DH UHT/HTST unit using a preheat temperature of 180° F., a flow rate of 2 liters/minute, a hold temperature of 290° F. for a hold time of 6 seconds. The liquid coffee extract is cooled to a temperature of 45° F. and packed into bottles.

Into each bottle, a coffee source component profile modifier (sodium hydroxide) and supplemental coffee source components for the relevant acids are added. The amount and species of the coffee source component profile modifier and the supplemental coffee source components added are shown in Table 3.2. The resulting coffee source component profile for the relevant acids, and the relative concentration ratios for those acids are also shown in Table 3.3.

TABLE 3.2

| | NaOH | malic | citric |
|---|---|---|---|
| Flavor Profile Modifier (NaOH) | 199.5 | | |
| Supplemental Coffee Source Components | | 66.6 | 191.3 |
| (added in acid form) | | | |
| Total Species Contribution | | 66.6 | 191.3 |

Following the addition of the coffee source component profile modifier and the supplemental coffee source components the pH of the coffee is measured to be 5.488. The bottles are then placed in an 85° F. controlled temperature room that is monitored by a Partlow model MRC 5000 temperature control system for two weeks. At the conclusion of two weeks, the bottles are removed, and the pH of the coffee is measured to be 5.133. The resulting coffee source component profile and the relative concentration ratios of the resulting coffee source components is determined. Their values appear in Table 3.3. The resulting coffee source component profile is compared to the target coffee source component profile and the differences are also shown in Table 3.3.

TABLE 3.3

| | pH | malic | citric |
|---|---|---|---|
| Resulting Coffee Source Component | 5.133 | 116.5 | 311.4 |
| Profile | | | |
| Relative Ratio of Acids (A) in | | 1 | 2.67 |
| Resulting Coffee Source Component | | | |
| Profile | | | |
| Target Coffee Source Component | | 49.9 | 120.1 |
| Profile | | | |
| Relative Ratio of Acids (A) in Target | | 1 | 2.41 |
| Coffee Source Component Profile | | | |
| Difference of relative ratio values | 0.071 | 0 | 0.26 |
| between an acid in the target profile | | | |
| and the corresponding acid in the | | | |
| resulting profile. | | | |
| Relative concentration ratio of acid | | 1 | 1.11 |
| in resulting profile/Relative | | | |
| concentration ratio of corresponding | | | |
| acid in target profile. | | | |

The concentrations of the perceptible forms of the relevant acids in the resulting coffee and the target coffee are calculated using the same pH value of 5.062 (the pH value of the freshly extracted coffee source). The perceptible concentrations in the resulting coffee are found to be at least as great as the perceptible concentrations of the corresponding relevant acids in the in the target coffee (i.e., the freshly extracted coffee source).

### Example 2

The liquid extract coffee source of Example 1 is utilized. The coffee source is diluted to 0.7% solids by weight using distilled water and a coffee source component profile is determined per the analytical method described herein. The coffee source component profile and relative concentration ratios are shown in Table 4.1.

TABLE 4.1

| | malic | citric | phosphoric | formic | lactic |
|---|---|---|---|---|---|
| Coffee | 49.9 | 120.1 | 37.2 | 50.3 | 18.6 |
| Source | | | | | |
| Component | | | | | |
| Profile | | | | | |
| Relative | 1 | 2.41 | 0.75 | 1.01 | 0.37 |
| Concentration | | | | | |
| Ratios | | | | | |

The pH of the liquid extract coffee source is measured using an ORION model 290A pH meter. The pH is observed to be 5.059. The coffee source is heated in a MicroThermics Model 25DH UHT/HTST unit using a preheat temperature of 180° F., a flow rate of 2 liters/minute, a hold temperature of 290° F. for a hold time of 6 seconds. The liquid coffee extract is cooled to a temperature of 45° F. and packed into bottles. Two 10 gram aliquots are taken and placed into scintillation vials.

Into each vial, a coffee source component profile modifier (sodium hydroxide) and supplemental coffee source components for the identified relevant acids are added. The amount and species of the coffee source component profile modifier and the supplemental coffee source components added are shown in Table 4.2. The resulting coffee source component profile for the relevant acids, and the relative concentration ratios for those acids are shown in Table 4.3.

TABLE 4.2

| | NaOH | malic | citric | phosphoric | formic | lactic |
|---|---|---|---|---|---|---|
| Flavor Profile Modifier | 83.6 | | | | | |
| Supplemental Coffee Source Components, | | 15.4 | 37 | 11.6 | 15.3 | 5.6 |
| acid form | | | | | | |
| Supplemental Coffee Source Components - | | 39.3 | 94.5 | 29.5 | | |
| salt form | | | | | | |
| Total Species Contribution | | 54.7 | 131.5 | 41.1 | 15.3 | 5.6 |

Following the addition of the flavor profile modifier and the supplemental coffee source components the pH of the aliquots is measured to be 5.439. The vials are then placed in an 85° F. controlled temperature room that is monitored by a Partlow model MRC 5000 temperature control system for two weeks. At the conclusion of two weeks, the vials are removed, and the pH of the aliquots are measured to be 5.059. The resulting coffee source component profile and the relative concentration ratios of the resulting coffee source components is determined. Their values appear in Table 4.3. The resulting coffee source component profile is compared to the target coffee source component profile and the differences are also shown in Table 4.3.

TABLE 4.3

| | NaOH | malic | citric | phosphoric | formic | lactic |
|---|---|---|---|---|---|---|
| Resulting Coffee Source Component Profile | 5.084 | 104.6 | 251.6 | 78.3 | 65.6 | 24.2 |
| Relative Ratio of Acids (A) in Resulting | | 1 | 2.41 | 0.75 | 0.63 | 0.23 |
| Coffee Source Component Profile | | | | | | |
| Target Coffee Source Component Profile | | 49.9 | 120.1 | 37.2 | 50.3 | 18.6 |
| Relative Ratio of Acids (A) in Target Coffee | | 1 | 2.41 | 0.75 | 1.01 | 0.37 |
| Source Component Profile | | | | | | |
| Difference of relative ratio values between | 0.025 | 0 | 0 | 0 | −0.38 | −0.14 |
| an acid in the target profile and the | | | | | | |
| corresponding acid in the resulting profile. | | | | | | |
| Relative concentration ratio of acid in | | 1 | 1 | 1 | 0.62 | 0.62 |
| resulting profile/ | | | | | | |
| Relative concentration ratio of | | | | | | |
| corresponding acid in target profile. | | | | | | |

The concentrations of the perceptible forms of the relevant acids in the resulting coffee and the target coffee are calculated using the same pH value of 5.059 (the pH value of the freshly extracted coffee source). The perceptible concentrations in the resulting coffee are found to be at least as great as the perceptible concentrations of the corresponding relevant acids in the in the target coffee (i.e., the freshly extracted coffee source).

### Example 3

The liquid extract coffee source of Example 1 is utilized. The coffee source is diluted to 0.7% solids by weight using distilled water and a coffee source component profile is determined per the analytical method described herein. The coffee source component profile and relative concentration ratios are shown in Table 5.1.

TABLE 5.1

| | malic | citric | phosphoric | formic | lactic |
|---|---|---|---|---|---|
| Coffee | 49.9 | 120.1 | 37.2 | 50.3 | 18.6 |
| Source | | | | | |
| Component | | | | | |
| Profile | | | | | |
| Relative | 1 | 2.41 | 0.75 | 1.01 | 0.37 |
| Concentration | | | | | |
| Ratios | | | | | |

The pH of the liquid extract coffee source is measured using an ORION model 290A pH meter. The pH is observed to be 5.059. The coffee source is heated in a MicroThermics Model 25DH UHT/HTST unit using a preheat temperature of 180° F., a flow rate of 2 liters/minute, a hold temperature of 290° F. for a hold time of 6 seconds. The liquid coffee extract is cooled to a temperature of 45° F. and packed into bottles. Two 10 gram aliquots are taken and placed into scintillation vials.

Into each vial, a coffee source component profile modifier (sodium hydroxide) and supplemental coffee source components for the identified relevant acids are added. The amount and species of the coffee source component profile modifier and the supplemental coffee source components added are shown in Table 5.2. The resulting coffee source component profile for the relevant acids, and the relative concentration ratios for those acids are shown in Table 53.

TABLE 5.2

| | NaOH | malic | citric | phosphoric | formic | lactic |
|---|---|---|---|---|---|---|
| Flavor Profile Modifier | 59.7 | | | | | |
| Supplemental Coffee Source Components, | | 14.6 | 29.2 | 13.1 | 16.3 | 6.6 |
| acid form | | | | | | |
| Supplemental Coffee Source Components - | | 39.3 | 69.1 | 39.5 | | |
| salt form | | | | | | |
| Total Species Contribution | | 53.9 | 98.3 | 52.6 | 16.3 | 6.6 |

Following the addition of the coffee source component profile modifier and the supplemental coffee source components the pH of the aliquots is measured to be 5.426. The vials are then placed in an 85° F. controlled temperature room that is monitored by a Partlow model MRC 5000 temperature control system for two weeks. At the conclusion of two weeks, the vials are removed, and the pH of the aliquots are measured to be 5.148. The resulting coffee source component profile and the relative concentration ratios of the resulting coffee source components is determined. Their values appear in Table 5.3. The resulting coffee source component profile is compared to the target coffee source component profile and the differences are also shown in Table 5.3.

TABLE 5.3

| | pH | malic | citric | phosphoric | formic | lactic |
|---|---|---|---|---|---|---|
| Resulting Coffee Source Component Profile | 5.148 | 103.8 | 218.4 | 89.8 | 66.6 | 25.2 |
| Relative Ratio of Acids (A) in Resulting | | 1 | 2.1 | 0.87 | 0.64 | 0.24 |
| Coffee Source Component Profile | | | | | | |
| Target Coffee Source Component Profile | | 49.9 | 120.1 | 37.2 | 50.3 | 18.6 |
| Relative Ratio of Acids (A) in Target Coffee | | 1 | 2.41 | 0.75 | 1.01 | 0.37 |
| Source Component Profile | | | | | | |
| Difference of relative ratio values between an | | 0 | −0.31 | +0.12 | −0.67 | −0.13 |
| acid in the target profile and the | | | | | | |
| corresponding acid in the resulting profile. | | | | | | |
| Relative concentration ratio of acid in | | 1 | 0.87 | 1.16 | 0.63 | 0.65 |
| resulting profile/ | | | | | | |
| Relative concentration ratio of corresponding | | | | | | |
| acid in target profile. | | | | | | |

The concentrations of the perceptible forms of the relevant acids in the resulting coffee and the target coffee are calculated using the same pH value of 5.059 (the pH value of the freshly extracted coffee source). The perceptible concentrations in the resulting coffee are found to be at least as great as the perceptible concentrations of the corresponding relevant acids in the in the target coffee (i.e., the freshly extracted coffee source).

### Example 4

The liquid extract coffee source of Example 1 is utilized. The coffee source is diluted to 0.7% solids by weight using distilled water and a coffee source component profile is determined per the analytical method described herein. The coffee source component profile and relative concentration ratios are shown in Table 6.1.

TABLE 6.1

| | malic | citric | phosphoric | formic | lactic |
|---|---|---|---|---|---|
| Coffee | 49.9 | 120.1 | 37.2 | 50.3 | 18.6 |
| Source | | | | | |
| Component | | | | | |
| Profile | | | | | |
| Relative | 1 | 2.41 | 0.75 | 1.01 | 0.37 |
| Concentration | | | | | |
| Ratios | | | | | |

A 5 liter sample of the liquid extract is collected. The pH of the liquid extract coffee source in the sample vials is measured using an ORION model 290A pH meter. The pH is observed to be 5.059. A coffee source component profile modifier (sodium hydroxide) and supplemental coffee source components for the identified relevant acids are added to the 5 liter sample. The amount and species of the coffee source component profile modifier and the supplemental coffee source components added are shown in Table 6.2.

The coffee source is heated in a MicroThermics Model 25DH UHT/HTST unit using a preheat temperature of 180° F., a flow rate of 2 liters/minute, a hold temperature of 290° F. for a hold time of 6 seconds. The liquid coffee extract is cooled to a temperature of 45° F. and packed into bottles. The resulting coffee source component profile for the relevant acids, and the relative concentration ratio ratios for those acids are shown in Table 6.3.

TABLE 6.2

| | NaOH | malic | citric | phosphoric | formic | lactic |
|---|---|---|---|---|---|---|
| Flavor Profile Modifier | 59.7 | | | | | |
| Supplemental Coffee Source Components, | | 14.6 | 29.2 | 13.1 | 16.3 | 6.6 |
| acid form | | | | | | |
| Supplemental Coffee Source Components - | | 39.3 | 69.1 | 39.5 | | |
| salt form | | | | | | |
| Total Species Contribution | | 53.9 | 98.3 | 52.6 | 16.3 | 6.6 |

Following the addition of the coffee source component profile modifier and the supplemental coffee source components the pH of the coffee is measured to be 5.245. The bottled coffee is then placed in an 85° F. controlled temperature room that is monitored by a Partlow model MRC 5000 temperature control system for two weeks. At the conclusion of two weeks, the bottled coffee is removed, and the pH of the coffee is measured to be 4.929. The resulting coffee source component profile and the relative concentration ratios of the resulting coffee source components is determined. Their values appear in Table 6.3. The resulting coffee source component profile is compared to the target coffee source component profile and the differences are also shown in Table 6.3.

TABLE 6.3

| | pH | malic | citric | phosphoric | formic | lactic |
|---|---|---|---|---|---|---|
| Resulting Coffee Source Component Profile | 4.929 | 103.8 | 218.4 | 89.8 | 66.6 | 25.2 |
| Relative Ratio of Acids (A) in Resulting | | 1 | 2.1 | 0.87 | 0.64 | 0.24 |
| Coffee Source Component Profile | | | | | | |
| Target Coffee Source Component Profile | | 49.9 | 120.1 | 37.2 | 50.3 | 18.6 |
| Relative Ratio of Acids (A) in Target Coffee | | 1 | 2.41 | 0.75 | 1.01 | 0.37 |
| Source Component Profile | | | | | | |
| Difference of relative ratio values between an | | 0 | −0.31 | +0.12 | −0.67 | −0.13 |
| acid in the target profile and the | | | | | | |
| corresponding acid in the resulting profile. | | | | | | |
| Relative concentration ratio of acid in | | 1 | 0.87 | 1.16 | 0.63 | 0.65 |
| resulting profile/ | | | | | | |
| Relative concentration ratio of corresponding | | | | | | |
| acid in target profile. | | | | | | |

The concentrations of the perceptible forms of the relevant acids in the resulting coffee and the target coffee are calculated using the same pH value of 5.059 (the pH value of the freshly extracted coffee source). The perceptible concentrations in the resulting coffee are found to be at least as great as the perceptible concentrations of the corresponding relevant acids in the in the target coffee (i.e., the freshly extracted coffee source).

### Example 5

The liquid extract coffee source of Example 1 is utilized. The coffee source is diluted to 0.7% solids by weight using distilled water and a coffee source component profile is determined per the analytical method described herein. The coffee source component profile and relative concentration ratios are shown in Table 7.1.

TABLE 7.1

| | malic | citric | phosphoric | formic | lactic |
|---|---|---|---|---|---|
| Coffee | 49.9 | 120.1 | 37.2 | 50.3 | 18.6 |
| Source | | | | | |
| Component | | | | | |
| Profile | | | | | |
| Relative | 1 | 2.41 | 0.75 | 1.01 | 0.37 |
| Concentration | | | | | |
| Ratios | | | | | |

A 5 liter sample of the liquid extract is collected. The pH of the liquid extract coffee source in the sample is measured using an ORION model 290A pH meter. The pH is observed to be 5.059. A coffee source component profile modifier (sodium hydroxide) and supplemental coffee source components for the identified relevant acids are added to the 5 liter sample. The amount and species of the coffee source component profile modifier and the supplemental coffee source components added are shown in Table 7.2.

The coffee source is heated in a MicroThermics Model 25DH ULHT/HTST unit using a preheat temperature of 180° F., a flow rate of 2 liters/minute, a hold temperature of 290° F. for a hold time of 6 seconds. The liquid coffee extract is cooled to a temperature of 45° F. and packed into bottles. The resulting coffee source component profile for the relevant acids, and the relative concentration ratios for those acids are shown in Table 7.3.

TABLE 7.2

| | NaOH | malic | citric | phosphoric | formic | lactic |
|---|---|---|---|---|---|---|
| Flavor Profile Modifier | 29.4 | | | | | |
| Supplemental Coffee Source Components, | | 30.7 | 29.2 | 13.1 | 16.3 | 6.6 |
| acid form | | | | | | |
| Supplemental Coffee Source Components - | | | 62.1 | 36.9 | | |
| salt form | | | | | | |
| Total Species Contribution | | 30.7 | 91.3 | 50 | 16.3 | 6.6 |

Following the addition of the coffee source component profile modifier and the supplemental coffee source components the pH of the bottled coffee is measured to be 5.239. The bottles are then placed in an 85° F. controlled temperature room that is monitored by a Partlow model MRC 5000 temperature control system for two weeks. At the conclusion of two weeks, the bottles are removed, and the pH of the coffee is measured to be 4.935. The resulting coffee source component profile and the relative concentration ratios of the resulting coffee source components is determined. Their values appear in Table 7.3. The resulting coffee source component profile is compared to the target coffee source component profile and the differences are also shown in Table 7.3.

TABLE 7.3

| | pH | malic | citric | phosphoric | formic | lactic |
|---|---|---|---|---|---|---|
| Resulting Coffee Source Component Profile | 4.935 | 80.6 | 211.4 | 87.2 | 66.6 | 25.2 |
| Relative Ratio of Acids (A) in Resulting | | 1 | 2.62 | 1.08 | 0.83 | 0.31 |
| Coffee Source Component Profile | | | | | | |
| Target Coffee Source Component Profile | | 49.9 | 120.1 | 37.2 | 50.3 | 18.6 |
| Relative Ratio of Acids (A) in Target Coffee | | 1 | 2.41 | 0.75 | 1.01 | 0.37 |
| Source Component Profile | | | | | | |
| Difference of relative ratio values between an | | 0 | +0.21 | +0.33 | −0.18 | −0.06 |
| acid in the target profile and the | | | | | | |
| corresponding acid in the resulting profile. | | | | | | |
| Relative concentration ratio of acid in | | 1 | 1.09 | 1.44 | 0.82 | 0.84 |
| resulting profile/ | | | | | | |
| Relative concentration ratio of corresponding | | | | | | |
| acid in target profile. | | | | | | |

The concentrations of the perceptible forms of the relevant acids in the resulting coffee and the target coffee are calculated using the same pH value of 5.059 (the pH value of the freshly extracted coffee source. The perceptible concentrations in the resulting coffee are found to be at least as great as the perceptible concentrations pf the corresponding relevant acids in the in the target coffee (i.e., the freshly extracted coffee source).

### Example 6

A roast and ground coffee is prepared comprising 65% by weight of a Central American Arabica, and 35% by weight of a Vietnam robusta. The blend is co-roasted to a Hunter color of 20.2 L. The roasted coffee is subsequently ground to an average particle size of 725 microns.

A coffee source comprising a liquid coffee extract is prepared from the roast and ground coffee above. The extraction column of Example 1 is filled with 5.9 kg of the prepared roast and ground coffee source. The column is flushed with nitrogen and then extracted with distilled, dearated water at the rate of 1.8 liters/minute at 180° F. The extract is cooled to 85° F. after exiting the column. The extract has a solids level of 4.2% by weight.

The coffee source comprising a liquid coffee extract is diluted to 0.7% solids by weight using distilled water and a coffee source component profile is determined per the analytical method described herein. The coffee source component profile and relative concentration ratios are shown in Table 8.1.

TABLE 8.1

| | malic | citric | phosphoric | formic | lactic |
|---|---|---|---|---|---|
| Coffee | 32.6 | 105.2 | 25.6 | 34.2 | 6.6 |
| Source | | | | | |
| Component | | | | | |
| Profile | | | | | |
| Relative | 1 | 3.23 | 0.79 | 1.05 | 0.20 |
| Concentration | | | | | |
| Ratios | | | | | |

A 5 liter sample of the liquid extract is collected. The pH of the liquid extract coffee source in the sample is measured using an ORION model 290A pH meter. The pH is observed to be 4.96. The coffee source is heated in a MicroThermics Model 25DH UHT/HTST unit using a preheat temperature of 180° F., a flow rate of 2 liters/minute, a hold temperature of 290° F. for a hold time of 6 seconds. The liquid coffee extract is cooled to a temperature of 45° F. and packed into bottles.

The bottles are then placed in an 85° F. controlled temperature room that is monitored by a Partlow model MRC 5000 temperature control system for two weeks. A coffee source component profile modifier (sodium hydroxide) and supplemental coffee source components for the identified relevant acids are added to the bottled extract samples. The amount and species of the flavor profile modifier and the supplemental coffee source components added are shown in Table 8.2. The resulting coffee source component profile for the relevant acids, and the relative concentration ratios for those acids are shown in Table 83.

TABLE 8.2

| | NaOH | malic | citric | phosphoric | formic | lactic |
|---|---|---|---|---|---|---|
| Flavor Profile Modifier | 56.7 | | | | | |
| Supplemental Coffee Source Components, | | 39 | | | 40.9 | 7.9 |
| acid form | | | | | | |
| Supplemental Coffee Source Components - | | | 125.7 | 30.5 | | |
| salt form | | | | | | |
| Total Species Contribution | | 39 | 125.7 | 30.5 | 40.9 | 7.9 |

Following the addition of the coffee source component profile modifier and the supplemental coffee source components the pH of the aliquots is measured to be 4.97. The resulting coffee source component profile and the relative concentration ratios of the resulting coffee source components is determined. Their values appear in Table 8.3. The resulting coffee source component profile is compared to the target coffee source component profile and the differences are also shown in Table 8.3.

TABLE 8.3

| | pH | malic | citric | phosphoric | formic | lactic |
|---|---|---|---|---|---|---|
| Resulting Coffee Source Component Profile | 4.97 | 71.6 | 230.9 | 56.1 | 75.1 | 14.5 |
| Relative Ratio of Acids (A) in Resulting | | 1 | 3.22 | 0.78 | 1.05 | 0.20 |
| Coffee Source Component Profile | | | | | | |
| Target Coffee Source Component Profile | | 32.6 | 105.2 | 25.6 | 34.2 | 6.6 |
| Relative Ratio of Acids (A) in Target Coffee | | 1 | 3.23 | 0.79 | 1.05 | 0.20 |
| Source Component Profile | | | | | | |
| Difference of relative ratio values between an | | 0 | −0.01 | −0.01 | 0 | 0 |
| acid in the target profile and the corresponding | | | | | | |
| acid in the resulting profile. | | | | | | |
| Relative concentration ratio of acid in resulting | | 1 | 1 | 0.99 | 1 | 1 |
| profile/ | | | | | | |
| Relative concentration ratio of corresponding | | | | | | |
| acid in target profile. | | | | | | |

The concentrations of the perceptible forms of the relevant acids in the resulting coffee and the target coffee are calculated using the same pH value of 4.96 (the pH value of the freshly extracted coffee source). The perceptible concentrations in the resulting coffee are found to be at least as great as the perceptible concentrations of the corresponding relevant acids in the in the target coffee (i.e., the freshly extracted coffee source).

### Example 7

A roast and ground coffee is prepared comprising 65% by weight of a Central American Arabica, and 35% by weight of a Vietnam robusta. The blend is co-roasted to a Hunter color of 20.2 L. The roasted coffee is subsequently ground to an average particle size of 725 microns.

A coffee source comprising a liquid coffee extract is prepared from the roast and ground coffee above. The extraction column of Example 1 is filled with 5.9 kg of the prepared roast and ground coffee source. The column is flushed with nitrogen and then extracted with distilled, dearated water at the rate of 1.8 liters/minute at 180° F. The extract is cooled to 85° F. after exiting the column. The extract has a solids level of 4.2% by weight.

The coffee source comprising a liquid coffee extract is diluted to 0.7% solids by weight using distilled water and a coffee source component profile is determined per the analytical method described herein. The coffee source component profile and relative concentration ratios are shown in Table 9.1.

TABLE 9.1

| | malic | citric | phosphoric | formic | lactic |
|---|---|---|---|---|---|
| Coffee | 32.6 | 105.2 | 25.6 | 34.2 | 6.6 |
| Source | | | | | |
| Component | | | | | |
| Profile | | | | | |
| Relative | 1 | 3.23 | 0.79 | 1.05 | 0.20 |
| Concentration | | | | | |
| Ratios | | | | | |

A 5 liter sample of the liquid extract is collected. The pH of the liquid extract coffee source in the sample is measured using an ORION model 290A pH meter. The pH is observed to be 4.96. The coffee source is heated in a MicroThermics Model 25DH UHT/HTST unit using a preheat temperature of 180° F., a flow rate of 2 liters/minute, a hold temperature of 290° F. for a hold time of 6 seconds. The liquid coffee extract is cooled to a temperature of 45° F. and packed into bottles.

The bottles are then placed in an 85° F. controlled temperature room that is monitored by a Partlow model MRC 5000 temperature control system for two weeks. A coffee source component profile modifier (sodium hydroxide) and supplemental coffee source components for the identified relevant acids are added to the bottled extract samples. The amount and species of the coffee source component profile modifier and the supplemental coffee source components added are shown in Table 9.2. The resulting coffee source component profile for the relevant acids, and the relative concentration ratios for those acids are shown in Table 9.3.

TABLE 9.2

| | NaOH | malic | citric | phosphoric | formic | lactic |
|---|---|---|---|---|---|---|
| Flavor Profile Modifier | 101.5 | | | | | |
| Supplemental Coffee Source Components, | | 21.6 | 69.7 | 17 | 22.7 | 4.4 |
| acid form | | | | | | |
| Supplemental Coffee Source Components - | | | | | | |
| salt form | | | | | | |
| Total Species Contribution | | 21.6 | 69.7 | 17 | 22.7 | 4.4 |

Following the addition of the coffee source component profile modifier and the supplemental coffee source components the pH of the aliquots is measured to be 4.98. The resulting coffee source component profile and the relative concentration ratios of the resulting coffee source components is determined. Their values appear in Table 9.3. The resulting coffee source component profile is compared to the target coffee source component profile and the differences are also shown in Table 9.3.

TABLE 9.3

| | pH | malic | citric | phosphoric | formic | lactic |
|---|---|---|---|---|---|---|
| Resulting Coffee Source Component Profile | 4.98 | 54.2 | 174.9 | 42.6 | 56.9 | 11 |
| Relative Ratio of Acids (A) in Resulting | | 1 | 3.23 | 0.79 | 1.05 | 0.20 |
| Coffee Source Component Profile | | | | | | |
| Target Coffee Source Component Profile | | 32.6 | 105.2 | 25.6 | 34.2 | 6.6 |
| Relative Ratio of Acids (A) in Target Coffee | | 1 | 3.23 | 0.79 | 1.05 | 0.20 |
| Source Component Profile | | | | | | |
| Difference of relative ratio values between an | | 0 | 0 | 0 | 0 | 0 |
| acid in the target profile and the corresponding | | | | | | |
| acid in the resulting profile. | | | | | | |
| Relative concentration ratio of acid in resulting | | 1 | 1 | 1 | 1 | 1 |
| profile/ | | | | | | |
| Relative concentration ratio of corresponding | | | | | | |
| acid in target profile. | | | | | | |

The concentrations of the perceptible forms of the relevant acids in the resulting coffee and the target coffee are calculated using the same pH value of 4.96 (the pH value of the freshly extracted coffee source). The perceptible concentrations in the resulting coffee are found to be at least as great as the perceptible concentrations of the corresponding relevant acids in the in the target coffee (i.e., the freshly extracted coffee source).

Having now described several embodiments of the present invention it should be clear to those skilled in the art that the forgoing is illustrative only and not limiting, having been presented only by way of exemplification. Numerous other embodiments and modifications are contemplated as falling within the scope of the present invention as defined by the appended claims thereto.

I claim:

1. A beverage composition comprising:
a coffee portion comprising a resulting coffee component, said coffee portion exhibiting a resulting coffee component profile, said coffee portion comprising:
i) a coffee source comprising a coffee source component, said coffee source exhibiting a coffee source component profile;
ii) a coffee source component modifier;
iii) a supplemental coffee source component;
wherein the amount of said resulting coffee component mimics the amount of a target coffee component in a component profile of a target coffee,
and wherein said coffee portion has a pH value in the range of from about 2.0 units below to about 2.0 units above the pH value of a coffee element of said target coffee.

2. The beverage composition of claim 1 wherein said coffee portion has a pH value in the range of from about 1.0 units below to about 1.0 units above the pH value of said coffee element of said target coffee.

3. The beverage composition of claim 1 wherein said coffee portion has a pH value in the range of from about 0.5 units below to about 0.5 units above the pH value of said coffee element of said target coffee.

4. The beverage composition of claim 1 wherein said coffee portion has a pH value in the range of from about 0.2 units below to about 0.2 units above the pH value of said coffee element of said target coffee.

5. The beverage composition of claim 1 wherein said coffee portion has a pH value in the range of from about 0.1 units below to about 0.1 units above the pH value of said coffee element of said target coffee.

6. The beverage composition of claim 1 wherein said coffee source is a roast and ground coffee.

7. The beverage composition of claim 1 wherein said coffee source is a soluble coffee .

8. The beverage composition of claim 1 wherein said coffee source is a coffee extract.

9. The beverage composition of claim 1 wherein said coffee source is a roast and ground blend of two or more coffee varieties.

10. A coffee composition comprising:
a coffee portion comprising a resulting coffee component, said coffee portion exhibiting a resulting coffee component profile, said coffee portion comprising:
i) a coffee source comprising a coffee source component, said coffee source exhibiting a coffee source component profile;
ii) a coffee source component modifier;
iii) a supplemental coffee source component;
wherein the amount of said resulting coffee component mimics the amount of a target coffee component in a component profile of a target coffee,
and wherein said coffee portion provides a pH value in use in the range of from about 2.0 units below to about 2.0 units above the pH value of a coffee element of said target coffee.

11. The beverage composition of claim 10 wherein said coffee portion provides a pH value in use in the range of from about 0.5 units below to about 0.5 units above the pH value of said coffee element of said target coffee.

12. The beverage composition of claim 10 wherein said coffee portion provides a pH value in use in the range of from about 0.2 units below to about 0.2 units above the pH value of said coffee element of said target coffee.

13. The beverage composition of claim 10 wherein said coffee portion provides a pH value in use in the range of from about 0.1 units below to about 0.1 units above the pH value of said coffee element of said target coffee.

14. The beverage composition of claim 10 wherein said coffee source is a roast and ground coffee.

15. The beverage composition of claim 10 wherein said coffee source is a soluble coffee.

16. The beverage composition of claim 10 wherein said coffee source is a coffee extract.

17. The beverage composition of claim 10 wherein said coffee source is a roast and ground blend of two or more coffee varieties.

18. A beverage composition comprising:
a coffee portion comprising a resulting coffee component, said coffee portion exhibiting a resulting coffee component profile, said coffee portion comprising:
i) a coffee source comprising a coffee source component, said coffee source exhibiting a coffee source component profile;
ii) a coffee source component modifier;
iii) a supplemental coffee source component;
wherein at a pH value equal to the pH value of a coffee element of a target coffee the amount of said resulting coffee component mimics the amount of a target coffee component in a component profile of said target coffee.

19. A beverage composition comprising:
a coffee portion comprising a resulting coffee component, said coffee portion exhibiting a resulting coffee component profile, said coffee portion comprising:
i) a coffee source comprising a coffee source component, said coffee source exhibiting a coffee source component profile;
ii) a coffee source component modifier;
iii) a supplemental coffee source component;
wherein when the pH value of the coffee portion is equal to the pH value of a coffee element of a target coffee the amount of said resulting coffee component mimics the amount of a target coffee component in a target coffee component profile.

20. A beverage composition comprising:
a coffee portion comprising a first resulting coffee component and a second resulting coffee component, said coffee portion exhibiting a resulting coffee component profile, said coffee portion comprising:
a) a coffee source comprising a first coffee source component and a second coffee source component, said coffee source exhibiting a coffee source component profile;
b) a coffee source component modifier;
c) a first supplemental coffee source component and a second supplemental coffee source component;
wherein when the pH value of the coffee portion is equal to the pH value of a coffee element of a target coffee:
(i) the ratio of said first resulting coffee source component to said second resulting coffee source component in said resulting coffee component profile is equal to the ratio of a first target coffee component to a second target coffee component;
(ii) the concentration of the associated form of said first resulting coffee component is greater than or equal to the concentration of the associated form of said first target coffee component; and
(iii) the concentration of the associated form of said second resulting coffee component is greater than or equal to the concentration of the associated form of said second target coffee component.

21. A beverage composition comprising:
a coffee portion comprising a first resulting coffee component, a second resulting coffee component, a third resulting coffee component, a fourth resulting coffee component, and a fifth resulting coffee component, said coffee portion exhibiting a resulting coffee component profile, said coffee portion comprising:
a) a coffee source comprising a first coffee source component, a second coffee source component, a third coffee source component, a fourth coffee source component, and a fifth coffee source component, said coffee source exhibiting a coffee source component profile;
b) a coffee source component modifier;
c) a first supplemental coffee source component, a second supplemental coffee source component, a third supplemental coffee source component, a fourth supplemental coffee source component, and a fifth supplemental coffee source component;
wherein when the pH value of the coffee portion is equal to the pH value of a coffee element of a target coffee:
(i) the ratio of said first resulting coffee source component to said second resulting coffee source component to said third resulting coffee source component, to said fourth resulting coffee source component to said fifth resulting coffee source component in said resulting coffee component profile is equal to the ratio of a first target coffee component to a second target coffee component, to a third target coffee component, to a fourth target coffee component, to a fifth target coffee component;
(ii) the concentration of the associated form of said first resulting coffee component is greater than or equal to the concentration of the associated form of said first target coffee component;
(iii) the concentration of the associated form of said second resulting coffee component is greater than or equal to the concentration of the associated form of said second target coffee component;
(iv) the concentration of the associated form of said third resulting coffee component is greater than or equal to the concentration of the associated form of said third target coffee component;
(v) the concentration of the associated form of said fourth resulting coffee component is greater than or equal to the concentration of the associated form of said fourth target coffee component; and,
(vi) the concentration of the associated form of said fifth resulting coffee component is greater than or equal to the concentration of the associated form of said fifth target coffee component.
